(19) United States
(12) Patent Application Publication
(10) Pub. No.: US 2007/0198151 A1
(43) Pub. Date: Aug. 23, 2007

(54) Method And Chassis Arrangement For Controlling The Driving Stability Of A Motor Vehicle

(76) Inventor: Martin Munster, Friedrichshafen (DE)

Correspondence Address: DAVIS & BUJOLD, P.L.L.C., 112 PLEASANT STREET, CONCORD, NH, 03301, US

(21) Appl. No.: 10/593,604

(22) PCT Filed: Jan. 28, 2005
(86) PCT No.: PCT/EP05/00821

§ 371 Date: Sep. 22, 2006

(30) Foreign Application Priority Data
Mar. 25, 2004 (DE) 10 2004 014 576.8

(51) Int. Cl. B60G 17/018

(52) U.S. Cl. 701/37

(57) ABSTRACT

A method for controlling the driving stability of a vehicle, by which a rear camber angle of the wheels of the rear axle is actively adjusted depending on a driving situation, and a front anti-rolling torque is exerted on the front axle and a rear anti-rolling torque is exerted on the rear axle. The inventive method is characterized by a rolling torque distribution which represents the ratio of the rear anti-rolling torque to the front anti-rolling torque is adjusted depending on the rear camber angle of the wheels on the rear axle. The invention also relates to a chassis arrangement for carrying out the inventive method.

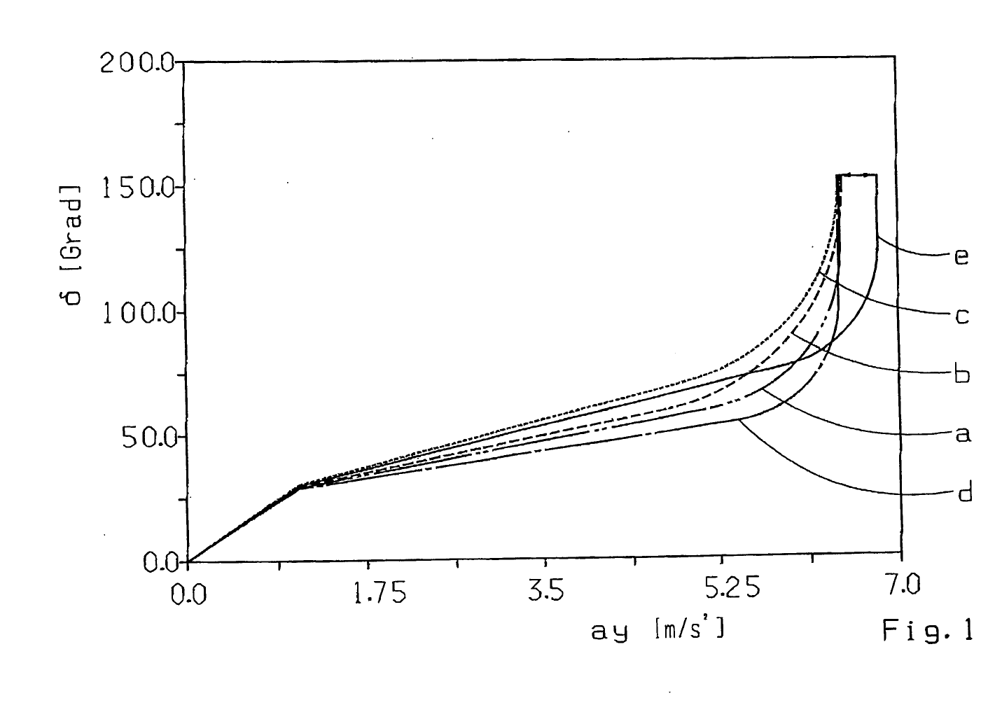

This application is a national stage completion of PCT/EP2005/000821 filed Jan. 28, 2005, which claims priority from German Application Serial No. 10 2004 014 576.8 filed Mar. 25, 2004.

### FIELD OF THE INVENTION

The invention concerns a method and a chassis arrangement for regulating the driving stability of a motor vehicle.

### BACKGROUND OF THE INVENTION

Various conceptual possibilities and procedures are known for controlling driving stability of a motor vehicle. Active stabilizers are therefore used for compensation of the swaying tendency due to a transverse acceleration encountered when turning. As a rule, both vehicle axles are equipped with active stabilizers for this, and the supporting moment or anti-swaying moment exerted by the active stabilizers is distributed constantly or in part also variably to both of the vehicle axles.

Furthermore, methods and arrangements are known for changing the camber angle in wheel suspensions of motor vehicles. For axle designs with a passive, self-activating kinematic camber adjustment, the suspension is adjusted passively by the swaying movements and influencing radial forces. For axle designs with active camber adjustment, the camber angle is changed by one or more actuators also without the effect of swaying movements or radial forces. Such camber adjustment devices are, as a rule, arranged on the rear axle since their implementation on the front axle is difficult because of the reduced space availability, the large maximum turning angle, as well as the drive shafts on driven axles.

By a camber adjustment at the rear axle, the transferable lateral driving forces are increased so that, relative to conventional motor vehicles with identical driving maneuvering, the required axle king pin inclination is reduced.

By the reduction of the king pin inclination at the rear axle with unchanged king pin inclination at the front axle, there is changed, however, the roll steer effect of the vehicle toward an understeering tendency. This underlies the simultaneous reduction of the yaw angle, caused by the reduced king pin inclination at the rear axle equipped with a camber correction device. In order to follow the desired driving course without further deviation, the king pin inclination at the front axle must be increased by sharp turning so that the desired yaw angular velocity is achieved or maintained. This effect is favored by the uneven distribution of the swaying resistance on the vehicle axles since, normally on the front axle, there is a higher swaying resistance present than at the back axle and, therefore, also at the front axle higher cornering forces are required. Therefore a camber correction increases in the rear axle also the cornering at the rear axle, although the greater support component is produced at the front axle.

The use of active stabilizer is problematic with additionally provided passive camber adjustments, since passive camber adjustments are necessary for changing the camber of the swaying movements of the motor vehicle body. If these swaying movements are compensated by active stabilizers or other swaying stabilization systems, an effective camber adjustment is no longer possible, since no significant angle changes occur.

With this background, the object of the invention is to create a method and a chassis arrangement for regulating the driving stability of a motor vehicle which facilitates both a high resistance to swaying as well as high cornering forces with neutral road performance.

### SUMMARY OF THE INVENTION

The invention is based on the knowledge that the understeering effecting adaptation of the camber angle in which the wheels both incline farther toward the inside of the vehicle and thereby form a curve, can be combined advantageously with active stabilizers. According to the invention, there are at least active camber adjusting devices combined at the rear axle with active stabilizers.

With active stabilizers, the distribution of the swaying moment and, therefore, the necessary cornering can be transferred between the axles whereby a shifting of the swaying support to the rear axle, the understeering effecting adaptation of the camber angle can be wholly or partly compensated. By shifting the swaying support to the rear axle, therefore, the additional cornering potential developed there through the adaptation of the camber is also actually invoked. Therefore greater cornering forces can be achieved and also exerted without negatively influencing the roll steer effect.

Accordingly, the invention describes a procedure for regulating the driving stability of a vehicle wherein, as a function of a driving conviction, a rear wheel camber angle of the wheels of the rear axle is actively adjusted and, at the front axle, a front anti-sway moment and, at the rear axle, a rear anti-sway moment are exerted. Moreover, the ratio of the rear anti-sway moment to the front anti-sway moment feeding back the sway moment distribution adjusts the wheels of the rear axle as a function of the rear wheel camber angle.

In an advantageous arrangement, this procedure can be equipped such that the ratio of the rear anti-sway moment to the front anti-sway moment is increased, if the camber angle of the wheels of the rear axle is reduced.

Moreover it can be provided that only the rear wheel camber angle of the wheels of the rear axle is actively adjusted and the front wheel camber angle of the wheels of the front axle is passively adjusted.

According to one variation of the invention, first of all, there is an adjustment of the driving stability made, according to the rear wheel camber angle, and subsequently the sway moment distribution is adapted to the adjusted rear wheel camber angle.

An independent variation thereof provides that the rear wheel camber angle and the sway moment distribution are adjusted to a determined driving condition according to a family of characteristics. Here the time series of the adjustment of the sway moment distribution and wheel camber angle are variable as a function of the determined driving condition.

Finally, it can be provided that only the rear wheel camber angle is actively adjusted and that the front wheel camber angle is adjusted passively, i.e., it is adjusted by self-activation.

The chassis of arrangement, according to the invention, includes at least actuators for adjusting a rear wheel camber angle of the wheels of the rear axle of the vehicle; a front active stabilizer for adjusting a front anti-sway moment at the front axle, and a rear active stabilizer for adjusting a rear anti-sway moment at the rear axle, whereby a control arrangement for adjusting a sway moment distribution is provided, giving as feedback the ratio of the rear anti-sway moment to the front anti-sway moment, as a function of the wheel camber angle of the wheels of the rear axle. Thereby one actuator or also several actuators can be provided at each rear wheel.

In a preferred arrangement of this vehicle chassis arrangement, it is provided that the steering arrangement is formed in such a way that with the latter the ratio of the rear anti-sway moment to the front anti-sway moment is increased when the rear wheel camber angle of the wheels of the rear axle is reduced.

Finally, it can be provided that at the wheel suspensions, the wheels of the front axle are provided with only passive wheel camber adjustment devices.

By a driving dynamic potential gain, in addition according to the invention, can be used both for a comfortable balance within an achievable limit also with a passive vehicle, as well as for an increase of the limit with a spring arrangement corresponding to the passive vehicle. This variation to a comfortable and/or a sporty driving behavior can be achieved with merely small changes to the basic chassis so that, according to the invention, with small hardware type variations, a large bandwidth of vehicle characteristics can be selected.

### BRIEF DESCRIPTION OF THE DRAWING

The invention will now be described, by way of example, with reference to the accompanying drawing in which:

The FIGURE shows a diagram of a steering wheel angle to be adjusted as a function of the lateral acceleration encountered in various driving stability regulations or chassis arrangements.

### DETAILED DESCRIPTION OF THE INVENTION

In the FIGURE is shown the steering wheel angle δ in degrees as a function of the lateral acceleration ay encountered in the vehicle in meters per second squared returned for a chassis with:
a a passive chassis arrangement without active components for camber adjustment or sway moment support
b a constant camber=0° without active stabilizers
c negative camber without active stabilizers
d positive camber without active stabilizers, and
e negative camber and active stabilizers.

The influence of the wheel camber adjustment on the roll steer effect is shown by this diagram. First of all, the influence of a wheel camber adjustment is shown on the roll steer effect with and without adapted sway stiffness distribution by the stabilizers. Opposite the curve a, of a passive vehicle without active chassis components, there is a negative increasing wheel camber angle according to curve c for vehicles with an active camber adjustment to a significant increase of the understeering tendency of the vehicle, which results in an increased steering requirement and a reduced steering willingness. Since a positive real camber angle is adjusted, because of the encountered sway angle in the passive vehicle, which leads to what is already shown in curve b, the camber angle kept constant at 0° in vehicles with camber correction, slightly increased understeering. Conversely, according to curve d, it is possible to neutralize the roll steer effect by a positive camber angle whereby, however, the limit of the achievable cornering force is reduced.

According to curve e, an approximately 5% higher limiting cross acceleration is achieved by an adjustment of a negative camber and with the use of stabilizers, which is shown by the arrow at the upper end point of the curve. In this case, further increases are possible, according to the invention, to the effect that also the understeering behavior in a broad range is improved by the active stabilizers.

### REFERENCE NUMERALS

a characteristic curve of a passive chassis arrangement without active component for camper adjustment or sway moment support
b characteristic curve of a chassis arrangement with constant camber without active stabilizers
c characteristic curve of a chassis arrangement with negative camber without active stabilizers
d characteristic curve of a chassis arrangement with positive camber without active stabilizers
e characteristic curve of a chassis arrangement with negative camber and active stabilizers
ay cross acceleration of the vehicle
δ steering wheel angle of the vehicle

1-4. (canceled)

5. A method for regulating driving stability of a vehicle as a function of a driving condition, the method comprising the steps of:
actively adjusting a rear wheel camber angle of wheels of a rear axle;
exerting a front anti-sway moment, of a front axle, and a rear anti-sway moment, at the rear axle; and
adjusting a sway moment distribution, which is feed back of a ratio of the rear anti-sway moment to the front anti-sway moment, as a function of a rear wheel camber angle of the wheels of the rear axle.

6. The method according to claim 5, further comprising the step of increasing the ratio of the rear anti-sway moment to the front anti-sway moment when the rear wheel camber angle of the wheels of the rear axle is reduced.

7. The method according to claim 5, further comprising the step of only actively adjusting the rear wheel camber angle of the wheels of the rear axle and passively adjusting a front wheel camber angle of the wheels of the front axle.

8. The method according to claim 5, further comprising the step of first regulating the driving stability according to the rear wheel camber angle, and then adapting the sway moment distribution to the adjusted rear wheel camber angle.

9. The method according to claim 5, further comprising the steps of determined driving condition according to a characteristic curve and adjusting the rear wheel camber angle and the way moment distribution according to the driving condition.

10. A chassis arrangement for driving stability regulation of a vehicle, the chassis arrangement comprising:
actuators for adjusting a wheel camber angle of wheels of a rear axle of the vehicle;
a front active stabilizer for adjusting a front anti-sway moment of a front axle;
a rear active stabilizer for adjusting a rear anti-sway moment of the rear axle; and
a control device for adjusting a sway moment distribution, which is feed back of a ratio of the rear anti-sway moment to the front anti-sway moment, as a function of the wheel camber angle of the wheels of the rear axle.

11. The chassis arrangement according to claim 10, wherein the control device increases the ratio of the rear anti-sway moment to the front anti-sway moment when the rear wheel camber angle of the wheels of the rear axle is reduced.

12. The chassis arrangement according to claim 10, wherein only passive wheel camber adjustments are provided at wheel suspensions of wheels of the front axle.
